(19) United States
(12) Patent Application Publication
(10) Pub. No.: US 2021/0224636 A1
(43) Pub. Date: Jul. 22, 2021

(54) SYSTEM AND METHOD FOR INTERFACING A BIOLOGICAL NEURAL NETWORK AND AN ARTIFICIAL NEURAL NETWORK

(71) Applicant: Pegah AARABI, Richmond Hill (CA)

(72) Inventor: Pegah AARABI, Richmond Hill (CA)

(21) Appl. No.: 16/748,060

(22) Filed: Jan. 21, 2020

(51) Int. Cl. G06N 3/06; G06N 3/063; G06N 3/04

(52) U.S. Cl. CPC G06N 3/061; G06N 3/0454; G06N 3/063

(57) ABSTRACT

The present disclosure provides a system and method for interfacing a biological neural network and an artificial neural network. The system and method comprises an interface layer comprising electrically conductive nodes to relay a transmission of neural data from the biological neural network to the artificial neural network, the artificial neural network comprising a communication interface to receive the transmission of neural data from the interface layer, a processor to translate the transmission of neural data into an artificial memory data, and a memory to store the artificial memory data.

### FIELD OF INVENTION

The present disclosure relates to a system and method for interfacing a biological neural network and an artificial neural network.

### BACKGROUND

A person's memory can be considered to shape that person's essence. How a person acts in a certain situation, or whether that person can draw on their previous experience determines who that person is. As a person ages, the brain ages as well, and loses its effectiveness of being able to retain memories. In other cases, people growing older may experience dementia or other illnesses that make it difficult to recall memories. Ultimately however, a person will cease to exist, and that person's memories and experiences will disappear with that person.

### SUMMARY

The present disclosure provides for interfacing a biological neural network and an artificial neural network. More particularly, the present disclosure relates to various techniques for retrieving memories and neural data from biological neural networks, saving the data in artificial neural networks, and placing memories and neural data back into biological neural networks. An interface layer may include electrically conductive nodes to relay a transmission of neural data from the biological neural network to the artificial neural network. The artificial neural network may include a communication interface to receive the transmission of neural data from the interface layer. A processor may translate the transmission of neural data into an artificial memory data, and a memory may store the artificial memory data.

### BRIEF DESCRIPTION OF THE DRAWINGS

FIG. 1 is a block diagram of a system for interfacing a biological neural network and an artificial neural network.

FIG. 2 is a flowchart of a method for the retrieval of transmissions of neural data from biological neural network and storing the data in the artificial neural network.

FIG. 3 is a flowchart of a method for the creation of artificial transmission of neural data and inputting them into the biological neural network.

FIG. 4 is a block diagram of the system of FIG. 1 during performance of the method depicted in FIG. 2 where data is being retrieved.

FIG. 5 is a block diagram of the system of FIG. 1 during performance of the method depicted in FIG. 3 where data is being inputted into the biological neural network.

FIG. 6 is a flowchart of a method for the parsing and compressing of artificial transmission of neural data.

FIG. 7 is a flowchart showing an example of the method depicted in FIG. 6 where parameters are parsed and compressed.

FIG. 8 is a schematic diagram of the interface model between a series of electrodes and neurons.

FIG. 9 is a graph of a parabolic impedance model where the center of an electrode has the least (baseline) impedance and the periphery of the electrode has the highest impedance (N times the baseline).

FIG. 10 is a diagram of a simulation of the loss of readability arising from an electrode connection that is 2k times larger than the neuron width.

FIG. 11 is a diagram of another simulation of the loss of readability arising from an electrode connection that is 2k times larger than the neuron width.

### DETAILED DESCRIPTION

As people age, their brains age as well. A natural side effect of this is that memories get harder and harder to recall. In addition to this, when a person passes away, their memories get lost forever. Loved ones lose the ability to connect to that person after they pass away.

Human memory can be considered a spectrum of impression, feeling, and thought that can range from general or amorphous to vivid and concrete. Work in this area falls into another spectrum. At one end, magnetic resonance imaging (MRI) and electroencephalography (EEG) are presently used to capture basic brain signaling. At the other end of the spectrum, much thought and work has been done towards the goal of being able to artificially store and recall memory with a high degree of verisimilitude. While the former is a present day reality, the latter is likely years or decades away. The present disclosure aims to contribute techniques to aid or speed the implementation of the goal of artificial memory storage and recall, while recognizing that short-term improvements may be limited to more the general or amorphous types of memories. The techniques discussed herein may find use in MRI/EEG or similar signaling which may ultimately be limited to storage/recall of a general impression. That said, it is contemplated that the techniques discussed herein will be useful in the achievement of the ultimate goal of artificial memory storage and recall.

One problem contemplated is how the interface between a human brain and artificial neural network. The interface layer described herein aims to solve this problem by providing an interface layer to read the signals from the human brain and transmit signals to the artificial neural network. One advantage of having an interface layer is that it can happen outside the body, and repeated attempts at interfacing with the human brain will not impact or damage the brain.

Still another problem is providing a complete system to communicate memories between biological and artificial neural networks. The techniques discussed herein provide efficient and scalable systems and methods to achieve this by translating neural data into a computer readable medium, and also by providing techniques to compress, parse and condense neural data into efficient and manageable sizes.

The present disclosure provides a system and method for interfacing a biological neural network and an artificial neural network, whereby a transmission of neural data from the biological neural network can be stored on the artificial neural network, allowing for the storage of memories and memory data. Furthermore, interfacing the biological neural network and the artificial neural network allows for the input of an artificial transmission of neural data into the biological neural network, allowing the injection of reminders and memories into the biological neural network.

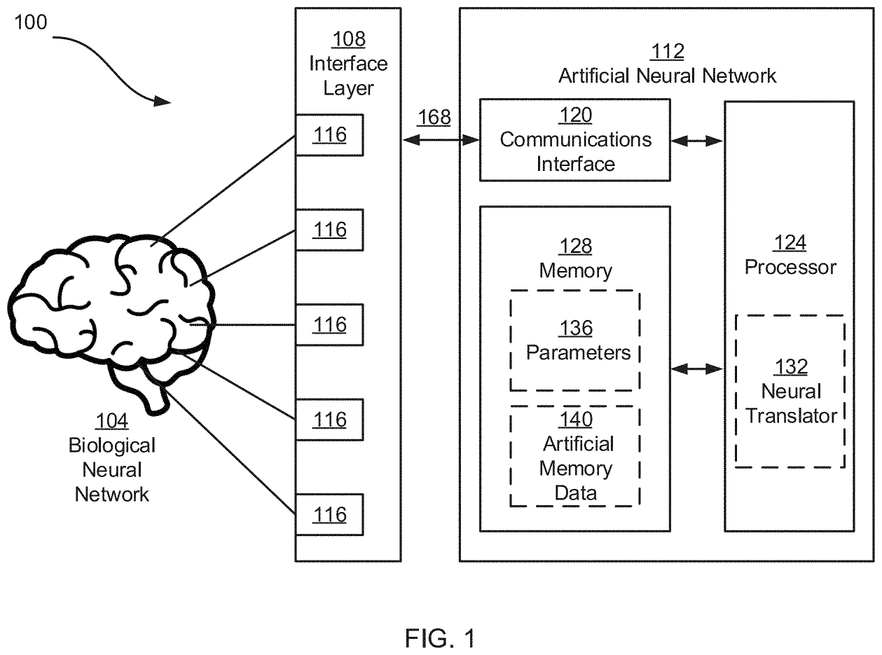

FIG. 1 depicts an example system for interfacing a biological neural network and an artificial neural network, system 100. System 100 includes a biological neural network 104, an interface layer 108 and an artificial neural network 112.

Biological neural network 104, for example a human brain, is composed of a group or groups of chemically connected or functionally associated neurons. Interface layer 108 is connected to biological neural network 104 through a series of electrically conductive nodes 116. Electrically conductive nodes 116 may be considered to be electrodes. Electrically conductive nodes 116 can be connected to any neural tissue, including both the central nervous system and the peripheral nervous system. Electrical signals are sent through electrically conductive nodes 116, where electrically conductive nodes 116 are physically in contact with biological neural network 104. This allows for a transmission of neural data 150, originating from biological neural network 104 in the form of electrical current, to be read by interface layer 108.

Interface layer 108 acts as a relay between biological neural network 104 and artificial neural network 112. Interface layer 108 is connected to biological neural network 104 through a series of electrically conductive nodes 116, which allow for the electrical conduction of electrical signals from biological neural network 104 to be received and relayed to artificial neural network 112. Electrically conductive nodes 116 can be connected to any neural tissue, including both the central nervous system as well as the peripheral nervous system, thereby interfacing the nervous system with interface layer 108. In the current embodiment, if biological neural network 104 were a brain, interface layer 108 is not limited to sitting directly on the brain, but can be external to a persons head, as long electrically conductive nodes 116 are able to receive electrical signals from biological neural network 104. Interface layer 108 is connected to artificial neural network 112 through a data link 168. Data link 168 is not particular limited in its configuration and can be any one of, or any suitable combination of, a wired and wireless link.

An example of an interface layer 108 is a liquid mixture that includes a silicon base and metal particles for enduring connection to biological neural network 104. The liquid silicon base provides increased elasticity over traditional rigid neural implants and conforms to the tissue of a biological neural network 104. A liquid silicon base may act similar to a surgical glue. The metal particles mixed in the liquid silicon base act as electrical conductors to channel electrical signals and data from biological neural network 104. The metal particles act as electrically conducting nodes 116. Further information regarding such materials can be found in “An Injectable Neural Stimulation Electrode Made from an In-Body Curing Polymer/Metal Composite” by Trevanthan, J. K. et al, which is incorporated herein by reference.

Another example of an interface layer 108 is made by inducing growth of a secondary biological neural network through the use of adult stem cells for neurogenesis in the central nervous system in parts that include the hippocampus and the spinal cord. This can be done by implanting adult stem cells and providing morphogens to promote neurogenesis. Neural tissue can also be grown in vitro with neural stem or progenitor cells in a 3D scaffold. Grafts can also be used to promote the growth. In an embodiment where interface layer 108 is grown, electrically conducting nodes 116 would also be inherently grown. Further information regarding such materials can be found in “Neural Tissue Engineering: Strategies for Repair and Regeneration” by Schmidt, Christine and Jennie Leach, “Experimental therapies for repair of the central nervous system: stem cells and tissue engineering” by Forraz, N et al, and “The development of neural stem cells” by Temple, Sally, which are incorporated herein by reference.

In another embodiment, interface layer 108 is a series of flexible thin optoelectronic devices for minimally invasive connection to biological neural network 104. The optoelectronic devices act as electrically conducting nodes 116 and transfer electrically conductive signals from biological neural network 104. Further information regarding such devices can be found in “Injectable, Cellular-Scale Optoelectronics with Applications for Wireless Optogenetics” by T. I. Kim et al, and “Flexible Near-Field Wireless Optoelectronics as Subdermal Implants for Broad Applications in Optogenetics” by G. Shin et al, which are incorporated herein by reference. is also incorporated by reference.

In an alternate embodiment, interface layer 108 is made of mesh electronics fabricated with sub cellular sized components within a flexible scaffold. The mesh electronics acts as conducting nodes 116, picking up electrical signals from biological neural network 104. Further information regarding such material can be found in “Precision electronic medicine in the brain” by S. R. Patel and C. M. Lieber, which is incorporated herein by reference.

Another embodiment of interface layer 108 is the creation of bi-directional electrical channels connected to a singular interface region. Bi-directional electrical channels can be created through biological means by growing, implanting or motivating the growth of a large number of biological conductive channels that start from biological neural network 104, and end at the interface region consisting of a plurality of conductive channel end points. Alternate technique of creating bi-directional electrical channels include the use of nano robotic devices to dig a channel from the interface region to biological neural network 104. Bi-directional electrical channels are made conductive using a liquid silicone base and conductive metal particles. This allows for the bi-directional electrical channels to act as electrically conductive nodes 116.

In all of the above embodiments of interface layer 108, interface layer 108 has electrically conductive nodes 116 connected to biological neural network 104. However, it is possible that electrically conductive nodes 116 may be imprecise as they may not necessarily be connected to an actual biological neuron on biological neural network 104. This can be corrected by training artificial neural network 112 using backpropagation in conjunction with biological neural network 104.

For the present example, a single electrode or electrically conductive node 116 is implanted near 2N biological neurons. It can be defined that N neurons firing an impulse via their axon has a voltage V and if N is not firing an impulse there is a voltage V of 0. In practice, neurons may not fire synchronously, but this example models the synchronous firing of N neurons with a similar voltage pulse V transmitted for a specific time interval. Electrically conductive node 116 will have a resistive connection to all N neural outputs with resistance RV1, RV2, RV3 to RVN for the neurons that fire an impulse of voltage V and electrically conductive node 116 will have a resistive connection to all N neural outputs with resistance R01, R02, R03 to R0N for neurons that do not fire an impulse. During the impulse firing, electrically conductive node 116 will have N parallel resistive connections to a voltage V and N parallel connections to a 0 or ground voltage. The effective resistance to voltage V, denoted as RV, can be modeled as equation 1:

$$R V = \frac{1}{\frac{1}{RV 1} + \frac{1}{R V 2} + \frac{1}{R V 3} + … + \frac{1}{R V N}} \qquad Equation 1$$

The effective resistance to the voltage 0, denoted as R0, can be modeled as equation 2:

$$R 0 = \frac{1}{\frac{1}{R0 \; 1} + \frac{1}{R 02} + \frac{1}{R 03} + … + \frac{1}{R 0 N}} \qquad Equation 2$$

Based on this, using a resistive voltage divider network, the voltage measured at electrically conductive node 116 (assuming no other resistances either in the neural connections or electrically conductive node 116 itself) becomes equation 3:

$$Vout = V \frac{R 0}{R 0 + R V} = V \frac{\begin{matrix}\frac{1}{R V 1} + \frac{1}{R V 2} + \\ \frac{1}{R V 3} + … + \frac{1}{R V N}\end{matrix}}{\begin{matrix}\begin{matrix}\frac{1}{RV 1} + \frac{1}{R V 2} + \frac{1}{R V 3} + … + \\ \frac{1}{R V N} + \frac{1}{R 01} + \frac{1}{R 02} +\end{matrix} \\ \frac{1}{R 03} + … + \frac{1}{R 0 N}\end{matrix}} \qquad Equation 3$$

Other embodiments of the model can include complex impedances for short-time neural pulses, or impendences related to electrically conductive node 116.

The model above can be used to simulate an imperfect interface layer 108 to biological neural network 104. By knowing the density of biological neural network 104, and the size of electrically conductive node 116, the voltage impulses observed by interface layer 108 can be observed and modelled. This allows artificial neural network 112 to attempt to correct for any loss or imperceptions from the imprecise interface layer 108.

Artificial neural network 112 includes a communications interface 120, a processor 124 and a memory 128. Memory 128 includes a non-transitory computer-readable medium that may include volatile storage, such as random-access memory (RAM) or similar, and may include non-volatile storage, such as a hard drive, flash memory, and similar.

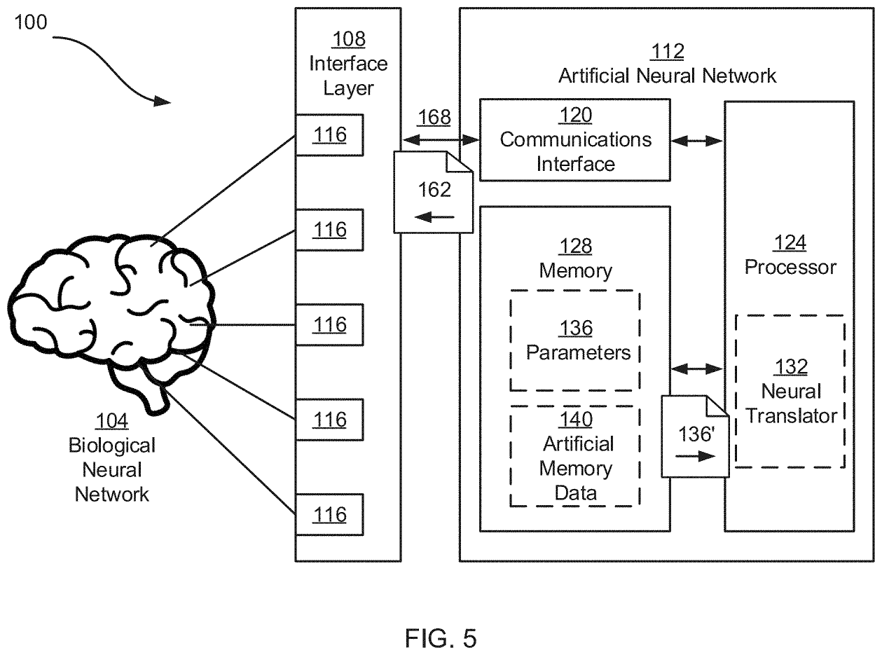

Memory 128 stores a plurality of parameters 136, and an artificial memory data 140. (Parameters 136 are referred to herein generically as parameter 136 and collectively as parameters 136. This nomenclature is used elsewhere herein). Parameters 136 are a blueprint or a series of building blocks to create an artificial transmission of neural data 162. (Artificial transmission of neural data 162 is further explained below, and is further depicted in FIG. 5. For example, an artificial transmission of neural data 162 used to reinforce a memory in biological neural network 104 to take medicine daily may have parameters 136 of the type of medicine being taken, the frequency in which to take the medicine, and the location of the medicine. It is contemplated that a different number of parameters in different combinations will be able to create different artificial transmissions of neural data 162.

Artificial neural network 112 includes processor 124, such as a central processing unit (CPU), interconnecting memory 128 and communications interface 120. Memory 128 stores computer-readable data and programming instructions, accessible and executable by processor 124. In the present embodiment, memory 128 stores parameters 136, which can be used by processor 124 to create artificial transmissions of neural data 162. Various forms of computer-readable programming instructions may be stored in memory 128 to be executed by processor 124.

In the present embodiment, processor 124 further includes a neural translator 132. Neural translator 132 translates transmissions of neural data 150 into artificial memory data 140. In the current embodiment, transmissions of neural data 150 received by communications interface 120 are translated by neural translator 132 into artificial memory data 140, which can then be stored in memory 128.

Artificial neural network 112 further includes communications interface 120. Communications interface 120 allows artificial neural network 112 to connect to other devices. In the current embodiment, communications interface 120 is used to connect to interface layer 108. Communications interface 120 can also connect artificial neural network 112 to input and output devices (not shown) via another computing device. Examples of input devices include, but are not limited to, a keyboard and a mouse. Examples of output devices include, but are not limited to a display showing a user interface. Alternatively, or in addition, the input and output devices can be connected to processor 124, or remote by connecting via another computing device via communications interface 120. Different input and output devices and a variety of methods of connecting to processor 124, either locally or via communications interface 120 may be used.

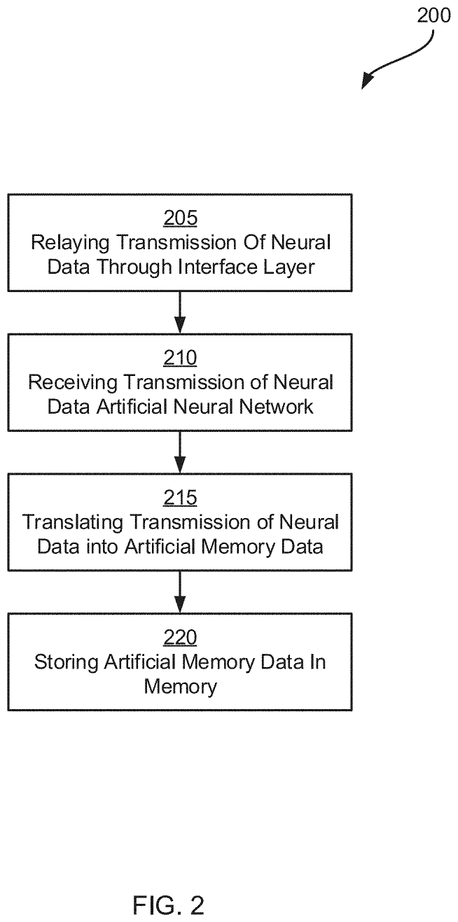

Referring now to FIG. 2, a method for interfacing a biological neural network and an artificial neural network and retrieving data from the biological neural network, method 200, is represented in the form of a flowchart which is generally indicated at 200. Method 200 can be performed using system 100, although it is understood that method 200 can be performed on variations of system 100, and likewise it is to be understood that method 200 can be varied to accommodate variations of system 100. Method 200 may be implemented by processor-executable instructions that may be stored in a non-transitory computer-readable medium.

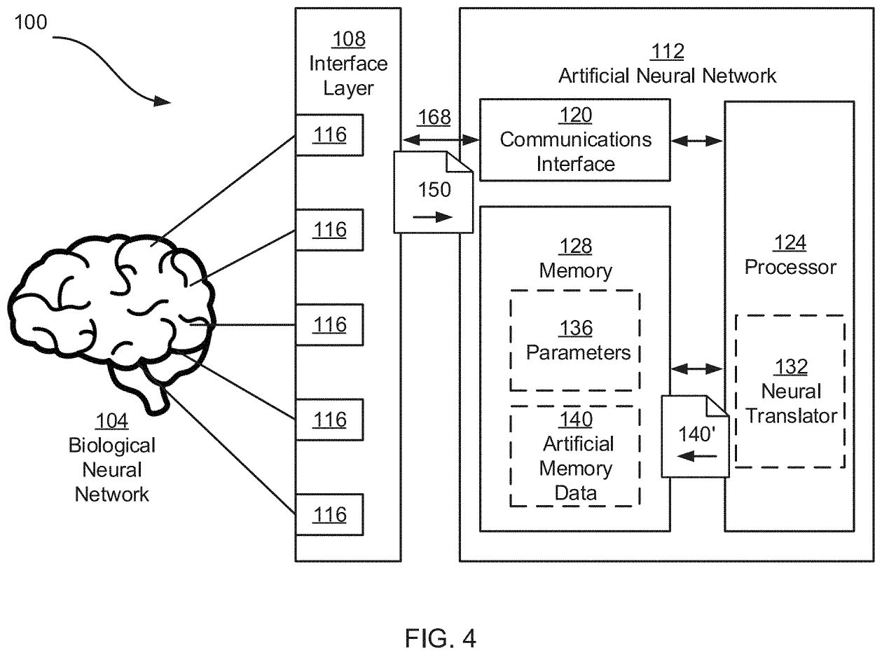

At block 205, interface layer 108 receives transmission of neural data 150 originating from biological neural network 104, and interface layer 108 relays the transmission of neural data 150 to communications interface 120 in artificial neural network 112. At block 210, communications interface 120 receives transmission of neural data 150. In the current embodiment, this is depicted in FIG. 4 where the arrow in transmission of neural data 150 indicates the direction of movement from interface layer 108 to communications interface 120.

At block 215, transmission of neural data 150 is translated by processor 124 into artificial memory data 140. In the current embodiment, neural translator 132 in processor 124 performs the translation. For example, transmission of neural data 150 is made up of electrical signal data. Neural translator 132 will convert the electrical signal data into a computer readable medium, such as binary, so that it can be stored by artificial neural network 112.

At block 220, artificial memory data 140 is stored in memory 128. In the current embodiment, this is depicted in FIG. 4 where artificial memory data 140′ is sent from processor 124 to memory 128 to be stored, ultimately becoming artificial memory data 140 in memory 128.

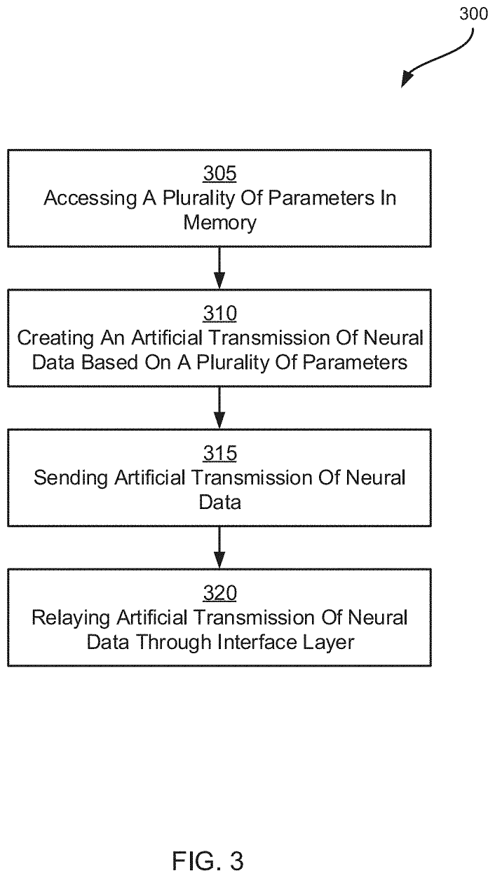

Referring now to FIG. 3, a method of for interfacing a biological neural network and an artificial neural network and inputting data from the artificial neural network into the biological neural network, method 300, is represented in the form of a flowchart which is generally indicated at 300. Method 300 can be performed using system 100, although it is understood that method 300 can be performed on variations of system 100, and likewise it is to be understood that method 300 can be varied to accommodate variations of system 100. Method 300 may be implemented by processor-executable instructions that may be stored in a non-transitory computer-readable medium.

At block 305, processor 124 accesses parameters 136 from memory 128 for the purpose of creating an artificial transmission of neural data 162. In the current embodiment, this is depicted in FIG. 5, where parameters 136′ is being accessed by processor 124 from memory 128. The creation of artificial transmission of neural data 162 is depicted at block 310. For example, if parameters 136 is a visual or pictorial representation of a person's 10^{th} birthday, then an artificial transmission of neural data 162 may be the number 10 in the form of electrical signals. Variations of parameters 136 can create different artificial transmissions of neural data 162.

At block 315 artificial transmission of neural data 162 is sent by communications interface 120 to interface layer 108. In the current embodiment, this is depicted in FIG. 5, where artificial transmission of neural data 162 is being sent from communications interface 120 to interface layer 108. At block 320, artificial transmission of neural data 162 is relayed through interface layer 108, through electrically conductive nodes 116 into biological neural network 104. In the current embodiment, by inputting the artificial transmission of neural data 162 into biological neural network 104, memories are inputted into biological neural network 104, allowing the biological neural network 104 to reinforce memories, or to incorporate new memories based on the artificial transmission of neural data 162. As an example, if artificial transmission of neural data 162 was “take medication”, then sending artificial transmission of neural data 162 would reinforce the biological neural network 104 to take medication if the memory of taking daily medication was already present. “A Successful Artificial Memory Has Been Created,” by Martone, R. is incorporated by reference.

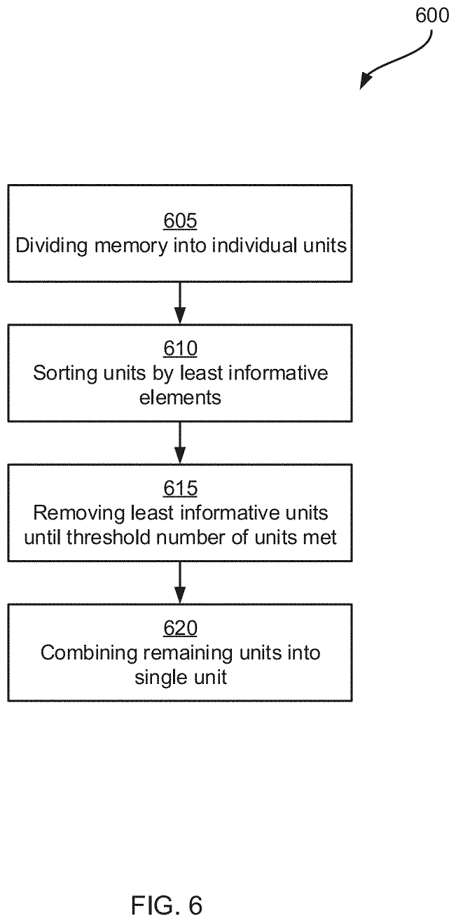

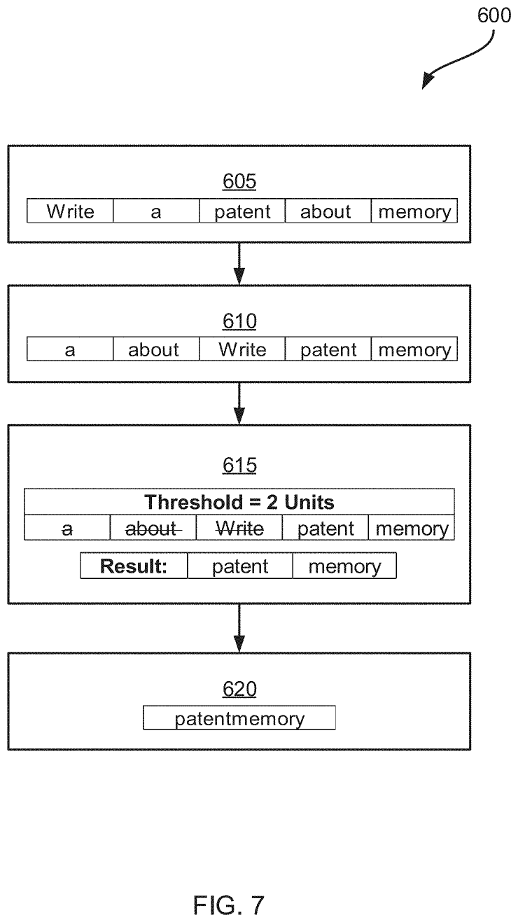

In making the process more efficient, condensed neural data may be sent in place of artificial transmission of neural data 162. Condensed neural data is efficient, as less data needs to be communicated to biological neural network 104, allowing for additional data to be transferred in a shorter amount of time. Referring now to FIG. 6, a method of for creating condensed neural data, method 600, is represented in the form of a flowchart which is generally indicated at 600. Method 600 can be performed using system 100, although it is understood that method 600 can be performed on variations of system 100, and likewise it is to be understood that method 600 can be varied to accommodate variations of system 100. Method 600 may be implemented by processor-executable instructions that may be stored in a non-transitory computer-readable medium. FIG. 7 depicts method 600 as well, however provides an example of each step.

At block 605, parameters 136 are divided into individual units by processor 124. For example, if parameter 136 were the phrase “Write a patent about memory”, then it would be divided into separate words, specifically “Write”, “a”, “patent”, “about”, “memory”. Any punctuation is removed at this step as well. This example depicted at block 605 in FIG. 7.

At block 610, the individual units would be sorted based on a scale. The scale could be information theoretic entropy, frequency of occurrence, lack of uniqueness of meaning, any other measure which can indicate the level of information of an element, or a combination of any of the above. The scale would be predetermined and provided to artificial neural network 112. In the current embodiment, the scale used is whether or not the individual unit has a uniqueness of meaning. Each individual unit would be given a redundancy score, and based on the redundancy score, the words are sorted into “a”, “about”, “Write”, “patent”, “memory”. This example is further depicted at block 610 in FIG. 7.

At block 615, the individual units are removed until there is a remaining predetermined threshold number of units left. In the current example, if the predetermined threshold was two units, then the units containing “a”, “about”, and “Write” would be removed. The remaining two units would be “patent” and “memory”. This example is further depicted at block 615 at FIG. 7. In another example, if there were seven individual units, and the predetermined threshold was three units, then four of the least informative units would be removed, leaving the three most informative units.

At block 620, the remaining units are combined into a single unit. In the current example of “patent” and “memory”, this would be combined into “patentmemory”. This would conclude the process of compressing and parsing artificial neural data 162 into condensed neural data, which could then be sent to biological neural network 104. It is contemplated that there are different variations on how to compress and parse artificial neural data 162 into condensed neural data for consumption by biological neural network 104.

Applications of the present disclosure may extend beyond saving memories from biological neural network 104 in artificial neural network 112. For example, transmissions of neural data 150 can be saved as artificial memory data 140, and then either returned to the same biological neural network 104 for neural regeneration, or sent to a different biological neural network 104, allowing memories to be moved from one person to another.

In other examples, processor 124 may contain a repeater to instruct communications interface 120 to transmit artificial transmission of neural data 162 at a series of timed intervals with the purpose of reinforcing suggestions within biological neural network 104.

According to another embodiment, interface layer 108 may include its own processor, allowing the translation process to occur within interface layer 108, and artificial memory data 140 can then be sent directly to memory 128 via communications interface 120. In other embodiments, partial translation may occur in interface layer 108, and further translation will be completed by processor 124. Different variations of where translation occur will now be apparent.

By using interface layer 108, the problem of interfacing between a human brain and artificial neural network 112 is solved, allowing for efficient and minimally invasive collection of neural data. In addition, by using condensing neural data, memories can be communicated efficiently and in a manageable manner between biological and artificial neural networks.

Regarding the interface layers discussed above, electrode density and precision may be considered as follows.

Current brain-computer interfaces consist of bulky electrodes which are larger than the actual neural connections in the brain, resulting in neural damage and loss of signal resolution as indicated in “Precision electronic medicine in the brain” by S. R. Patel and C. M. Lieber. Recent work in neural tissue engineering has achieved success with growing neural connections using adult stem cells for neurogenesis as well as the use of stem cells in conjunction with 3D scaffolds as indicated in “The development of neural stem cells” by Temple, Sally and in “Experimental therapies for repair of the central nervous system: stem cells and tissue engineering” by Forraz N. Another promising neural interface method involves injecting a conductive electrode (consisting of a silicone base and metal particles) as a liquid allowing for conformity to the biological structure that the liquid is injected in “An Injectable Neural Stimulation Electrode Made from an In” by Trevathan et al.

This method, combined with recent advancement in the field of nanorobotics (such as the work of “A swarm of slippery micropropellers penetrates the vitreous body of the eye” by Wu, Z. et al) is likely to one day enable complex conductive channels to be created from the surface of the skin to specific points within the brain, with the small robotic device creating a minimally-invasive channel which can then be filled by the silicone base and metal particles.

Other work in this area includes the use of flexible thin optoelectronic devices for minimally invasive connection to brain cells as contemplated in “Injectable, Cellular-Scale Optoelectronics with Applications for Wireless Optogenetics” by T.-I Kim et al, wireless connections to implanted optoelectronics attached to nerves as contemplated in “Flexible Near-Field Wireless Optoelectronics as Subdermal Implants for Broad Applications in Optogenetics” by F. Shin et al, as well as mesh electronics fabricated with sub-cellular sized components within a flexible scaffold as contemplated in “Precision electronic medicine in the brain” by S. R. Patel and C. M. Lieber.

One key challenge with mesh electronics is the non-direct neural connectivity (i.e. the received signal observed by the mesh is affected by multiple neurons and the transmitted signal affects multiple neutrons), resulting in an effective blurriness of both transmitted and received signals.

The advances outlined above provide a potential for a dense, flexible, and minimally-invasive direct interface between neurons in the brain and an external computing system. A key challenge becomes the encoding and decoding of neural data, which is made more complex by the lack of a one-to-one neuron-to-electrode connection.

Recent advances in deep Artificial Neural Networks (ANNs) have resulted in significant breakthroughs in artificial intelligence, ranging from human-like speech recognition accuracy to highly-accurate image segmentation as indicated in “Deep learning” by LeCun, Y., et al and “Hair segmentation using heuristically-trained neural networks” by Guo, W. and Aarabi, P.

Deep ANNs are well suited to decoding and encoding complex data. ANNs could also be well suited to decoding and encoding signals for the purpose of communication with biological neural networks, which would enable them to act as an interface layer neural network for the purpose of brain-computer interaction. Recent work in this area has shown the potential for deep ANNs in decoding electroencephalogram (EEG) signals as contemplated in “A Deep Learning Method for Classification of EEG Data Based on Motor Imagery” by An, Xiu et al.

While the momentum of recent advances makes the future development of direct interfaces between biological and artificial neural networks more likely, several key challenges remain.

First, in order to train and test interface layer deep ANNs, there will need to be a public dataset of recorded biological neural data (associated with specific input stimuli observed by the biological neural network). Such a dataset would accelerate research in decoding-layer interface neural networks.

Second, to further research in artificial data transmission to biological neural networks, the development of a biological neural network simulation would be helpful. Such a simulation would enable different encoding-layer ANNs to be tested and trained without any potential risk to a human subject.

Finally, for direct biological to artificial neural network interfaces, there would be the need for a physical interface with extreme density (matching the size and density of neural connections), depth variability (being able to reach multiple brain regions and layers), and precision in connectivity with specific neurons. Recent work in this last area is promising, but much more work remains to be done.

A model and framework for evaluating the effects of mismatched electrode-to-neural density, as well as imprecise connectivity, is proposed. By modeling the electrode to neuron interface, it is illustrated through simulations the effects of size and precision limitations.

In modelling electrode-neuron interfaces, a framework for modelling neural-electrode connectivity based on several simplifying assumptions is outlined.

First, it is assumed that neural output connections (via axons) are spaced 2β apart with a cross-sectional width of β, as shown in FIG. 1. It is further assumed that an artificially inserted electrode or conductive channel has a cross-sectional width of 2kβ and is spaced 4kβ apart. Essentially, it is assumed that gaps in neurons and electrodes are of the same size as the actual size of the corresponding neuron or electrode.

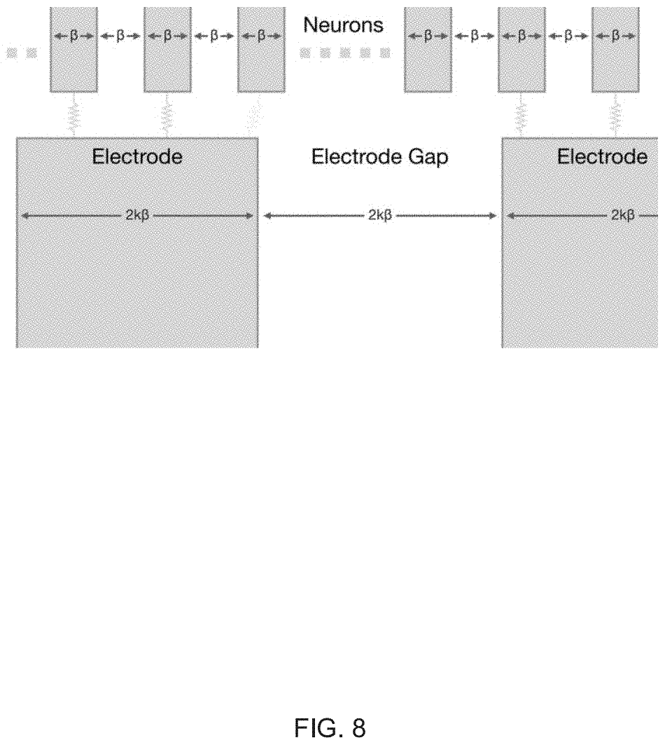

Referring to FIG. 8, neurons are smaller than the electrodes which results in electrode connections to potentially multiple neurons, and gaps in neural connectivity in regions with no electrodes.

As shown in FIG. 8, each electrode would connect to k+1 neurons with varying levels of connectivity (e.g. with varying resistances between the neuron outputs and the electrode). Also, due to the spacing between the electrodes there are blind spots or gaps where no electrode connects to a corresponding set of neurons.

Based on the simplified assumptions, there is a setup such that electrode n would connect to neurons 2kn to 2kn+k. Essentially, the assumption is that any connectivity to other neurons would have a high resistance such that it can be practically ignored, allowing focus on the k+1 closes neural connections for each electrode.

The k parameter in the model controls the density of the electrodes. A value of k=1 indicates a one-to-one match with the neurons, which is hard to achieve with current technology. A more typical realistic estimate is axons that have a cross-sectional width of 1 um and electrodes that are 10 um in size, resulting in a practical scenario for k of 5.

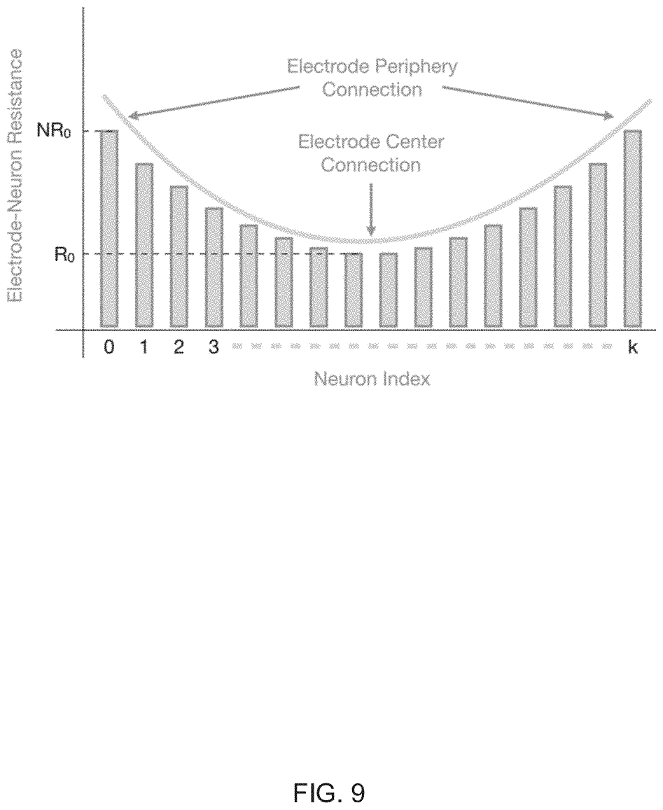

The resistance between the different neuron outputs and the corresponding electrode by a parabolic function is modeled and shown in FIG. 9. The minimum resistance is obtained at the center of the electrode and has a value of R0, while the maximum resistance is obtained at the edges of the electrode and has a value of NR0.

Assuming the parabolic resistance model with a minimum at R0 and periphery value of NR0 and the spacing outlined in FIG. 8, a resistance estimate Ω(i) between neuron i and its corresponding electrode can be obtained through equation 4:

Ω(i)=R₀[(N−1)(2i/k−1)²+1)] Equation 4:

In practice, impedance of the network needs to account both for real and imaginary resistance corresponding to time-varying effects resulting from capacitive aspects of an electrode-neural connection. In the above modelling, this aspect of the connect is ignored as a simplifying step for the analysis. However, any practical implementation will need to take this into account.

Based on the models, when an activation electrical pulse is generated by certain neurons, this should be observed as a voltage pulse by the electrode. Given the resistance network which may connect the electrode to multiple neurons, some of which might be firing an electrical pulse and some which may not be, the voltage observed by the electrode via a simple resistance divider network configuration can be calculated as shown in equation 5:

$${V}_{obs} = {V}_{act} \frac{{\sum }_{i ∈ X} {[ ( N - 1 ) {( 2 i \text{/} k - 1 )}^{2} + 1 ]}^{- 1}}{{\sum }_{i = 0}^{k} {[ ( N - 1 ) {( 2 i \text{/} k - 1 )}^{2} + 1 ]}^{- 1}} \qquad Equation 5$$

V_{act} is the generated voltage as a result of the neurons firing an electrical pulse, and where X consists of the set of activated neurons (e.g. whose output voltage is V_{act}).

Note that R0 is not present in the final V_{obs} equation, allowing focus on the resistance multiplier N. A small N indicates more uniformity in the resistances and hence less precision in the electrode connection. A large N indicates a better connection with a single neuron and hence a higher connectivity precision.

Although the above discussion focuses on the cross-sectional interface between electrodes and neurons, a very similar process could be performed for 3D electrode meshes and neurons. Assuming a two-dimensional parabolic model, the observed voltage by the electrode could be defined as indicated in equation 6:

$${V}_{obs} = {V}_{act} \frac{{\sum }_{i , j ∈ X} {[ Ω ( i , j ) ]}^{- 1}}{{\sum }_{i = 0}^{k} {\sum }_{j = 0}^{k} {[ Ω ( i , j ) ]}^{- 1}} \qquad Equation 6$$

Estimate Ω(i,j) is the parabolic impedance function for a given electrode and neuron in row i and column j, and X is the set of all neurons which are activated by generating a voltage V_{act}.

In order simulate the effects of different neural interface electrode parameters, the model and assumptions described previously can be used. For these simulations, an image representative of the contents of one lawyer of a biological neural network of size 100×75 can be used.

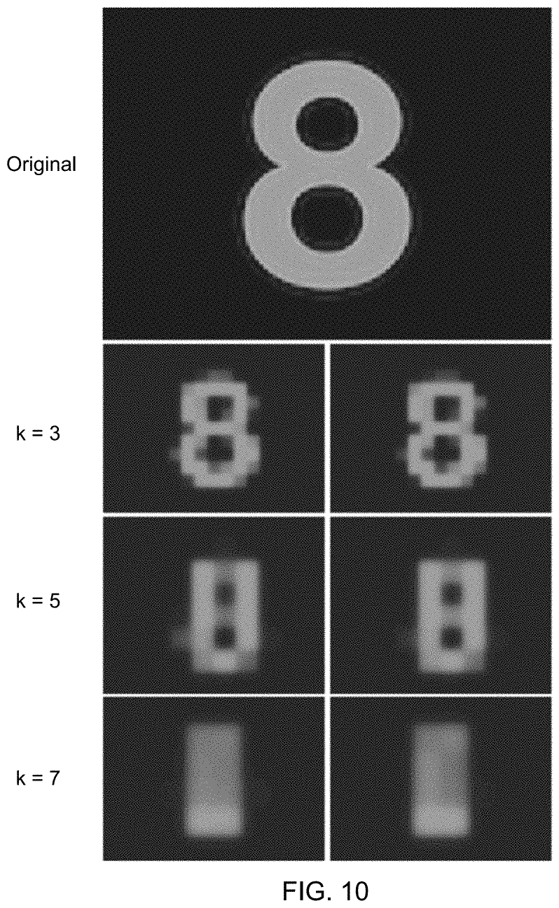

Based on a set value of k, the impedance network between the electrodes (of width 2kβ) and the neurons of size β can be modelled. As show in FIG. 10, the value of k makes a significant impact on the readability of the information as observed by the electrodes, with k=5 being a threshold for readability. This threshold is obviously dependent on the density of the data in the original network. Surprisingly, the value of N which impacts the level of precision of the electrode has a very minor adverse effect on readability, in that a low value (i.e. N=1) connects to more neurons uniformly and represents and overall clearer (though very slightly) picture of the data than a high value (i.e. N=100). Higher values focus the attention of the electrode to a single neuron and as a result slightly more data than lower values.

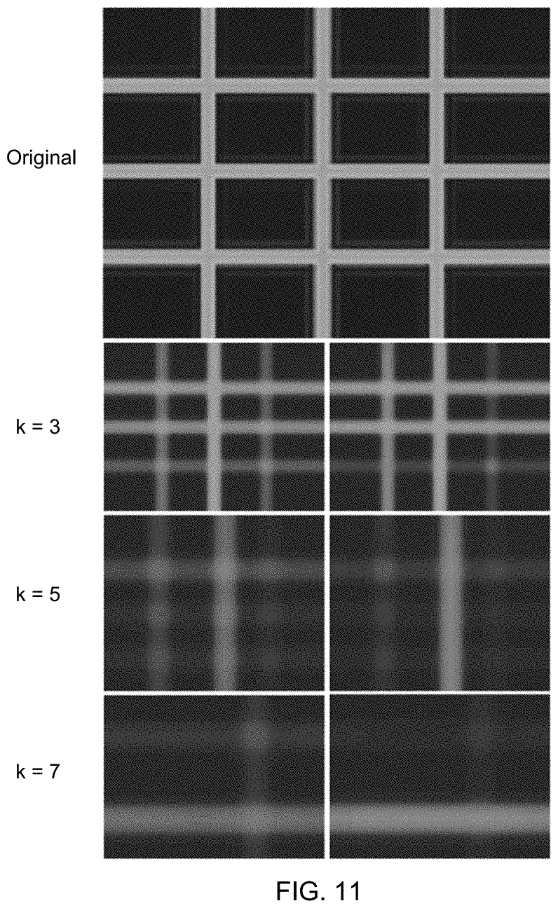

As shown in FIG. 11, a similar observation can be made that readability is very dependent on the electrode density, with a critical threshold occurring at k=5. Furthermore, higher N values appears to be less beneficial for readability than a small N value, again reinforcing our hypothesis that electrodes that uniformly connect to more neurons are better at extracting information than electrodes that connect better to specific neurons.

As illustrated above, a significant amount of recent progress in electrical connections directly to biological neurons has paved the way for potentially exciting research in decoding brain neural signals, augmenting biological neural networks with artificial neural networks, and better understanding the underlying functionality of the brain. In order for these potential areas to be viable for exploration, there is a need for more dense electrical interfaces (with density on par to the density of neural connections).

Once these interfaces are realized, the signals recorded from biological neural networks can be used as a basis for building a dataset which can be used for ANN research in decoding biological neural signals.

Finally, an artificial simulation of brain activity has the potential of enabling rapid development and exploration without the need for human experimentation.

However, as highlighted above, these efforts would not be fruitful unless the density of the electrodes (or equivalently, conductive channels) is large enough to allow for a reasonably accurate reading of neural signals. This density is more important, it appears, than the exact precision or consistency of the electrode-to-neuron connection.

It should be recognized that features and aspects of the various examples provided above can be combined into further examples that also fall within the scope of the present disclosure. In addition, the figures are not to scale and may have size and shape exaggerated for illustrative purposes.

1. A system for connecting to a biological neural network, the system comprising:
an interface layer comprising electrically conductive nodes to relay a transmission of neural data from the biological neural network to an artificial neural network;
the artificial neural network comprising:
a communication interface to receive the transmission of neural data from the interface layer;
a processor to translate the transmission of neural data into an artificial memory data; and
a memory to store the artificial memory data.

2. The system of claim 1, wherein:
the communication interface is to:
transmit an artificial transmission of neural data;
the processor is to:
create the artificial transmission of neural data to be sent by the communications interface to the interface layer to be relayed to the biological neural network;
the memory is to:
store a plurality of parameters for the processor to create the artificial transmission of neural data.

3. The system of claim 1, the interface layer further comprising:
a liquid mixture comprised of a silicon base and metal particles for enduring electrical conduction within the liquid mixture.

4. The system of claim 1, the interface layer further comprising:
a plurality of flexible thin optoelectronic devices for connecting to neurons in the biological neural network.

5. The system of claim 1, the interface layer further comprising:
a plurality of mesh electronics fabricated with sub cellular sized components within a flexible scaffold.

6. A method for connecting to a biological neural network, the method comprising:
receiving a transmission of neural data originating from the biological neural network, via an interface layer, using a communications interface in an artificial neural network;
translating the transmission of neural data using a processor in the artificial neural network into an artificial memory data; and
storing the artificial memory data using a memory in the artificial neural network.

7. The method of claim 6, further comprising:
creating an artificial transmission of neural data using the processor based on a plurality of parameters stored in the memory; and
sending the artificial transmission of neural data via the interface layer to the biological neural network using the communications interface.

8. A system for transferring data to a biological neural network, the system comprising:
an interface layer to relay an artificial transmission of condensed neural data from an artificial neural network to the biological neural network;
the artificial neural network comprising:
a communication interface to:
transmit the artificial transmission of condensed neural data;
a processor to:
create an artificial neural data from a plurality of parameters; and
parse and compress the artificial neural data into the artificial transmission of condensed neural data;
a memory to:
store the plurality of parameters for the processor to create the artificial neural data.

9. The system of claim 8, the processor further comprising:
a repeater to instruct the communications interface to transmit the artificial transmission of condensed neural data at a series of timed intervals to the biological neural network through the interface layer to reinforce suggestions within the biological neural network.

10. A method for transferring data to a biological neural network, the method comprising:
creating an artificial neural data using a processor based on a plurality of parameters on a memory;
compressing the artificial neural data into an artificial transmission of condensed neural data using the processor; and
sending the artificial transmission of condensed neural data using a communications interface to the biological neural network through an interface layer.

11. A method of claim 10, further comprising:
sending the artificial transmission of condensed neural data using a communications interface to the biological neural network through the interface layer at a series of timed intervals to reinforce suggestions within the biological neural network.

12. A method for transferring condensed neural data to a biological neural network, the method comprising:
dividing an artificial memory into at least one individual unit;
sorting the individual units by a redundancy score;
removing the individual units below a predetermined threshold number of units;
combining remaining predetermined threshold number of individual units into condensed neural data; and
sending the condensed neural data from an artificial neural network to biological neural network via an interface layer.
